(19) United States
(12) Patent Application Publication
(10) Pub. No.: US 2026/0121956 A1
(43) Pub. Date: Apr. 30, 2026

(54) PROTECTION OF MANAGEMENT NETWORK

(71) Applicant: Dell Products L.P., Round Rock, TX (US)

(72) Inventors: Parminder Singh SETHI, Punjab (IN); Pandiyarajan MANI, Gudiyattam (IN); Kavitha N, Bangalore (IN); Arun CHIDHAMBARAM, Bangalore (IN); Karthik ANBAZHAGAN, Bangalore (IN)

(73) Assignee: Dell Products L.P., Round Rock, TX (US)

(21) Appl. No.: 18/931,737

(22) Filed: Oct. 30, 2024

(51) Int. Cl. H04L 43/0817; H04L 41/18

(52) U.S. Cl. CPC H04L 43/0817; H04L 41/18

(57) ABSTRACT

An information handling system may include at least one processor, a memory, and a network interface. The information handling system may be configured to: receive an instruction to carry out an operation, wherein the operation includes shutting down at least one software service; determine whether the at least one software service includes a network service configured to allow remote access to the information handling system via the network interface; and in response to a determination that the at least one software service does include the network service, prevent the network service from shutting down.

### TECHNICAL FIELD

The present disclosure relates in general to information handling systems, and more particularly to protection of access to a network such as an out-of-band management network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As discussed in more detail below, some information handling systems may include a management controller that may be connected to a management network that is distinct from the usual data network that host systems use. It is important that the management controller remain reachable via its address on the management network, but various problems may lead to a loss of connectivity to the management network. This may lead to an inability to perform management tasks on the information handling system and other issues.

Embodiments of this disclosure address this problem by implementing protections for the service that handles the management controller's connectivity to the management network (e.g., a daemon such as NetworkD). By ensuring that NetworkD is not interrupted, access to the management controller may be maintained.

Although the specific example of a management controller's connection to a management network is described in detail herein, other embodiments may be applied in other situations. For example, some embodiments may be implemented on a host system instead of a management controller. Some embodiments may operate to maintain connectivity to a data network instead of a management network. One of ordinary skill in the art with the benefit of this disclosure will understand its wide applicability.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with maintaining remote access to an information handling system may be reduced or eliminated.

In accordance with embodiments of the present disclosure, an information handling system may include at least one processor, a memory, and a network interface. The information handling system may be configured to: receive an instruction to carry out an operation, wherein the operation includes shutting down at least one software service; determine whether the at least one software service includes a network service configured to allow remote access to the information handling system via the network interface; and in response to a determination that the at least one software service does include the network service, prevent the network service from shutting down.

In accordance with these and other embodiments of the present disclosure, a method may include an information handling system receiving an instruction to carry out an operation, wherein the operation includes shutting down at least one software service; the information handling system determining whether the at least one software service includes a network service configured to allow remote access to the information handling system via a network interface of the information handling system; and in response to a determination that the at least one software service does include the network service, the information handling system preventing the network service from shutting down.

In accordance with these and other embodiments of the present disclosure, an article of manufacture may include a non-transitory, computer-readable medium having computer-executable instructions thereon that are executable by an information handling system for: receiving an instruction to carry out an operation, wherein the operation includes shutting down at least one software service; determining whether the at least one software service includes a network service configured to allow remote access to the information handling system via a network interface of the information handling system; and in response to a determination that the at least one software service does include the network service, preventing the network service from shutting down.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example method, in accordance with embodiments of the present disclosure.

### DETAILED DESCRIPTION

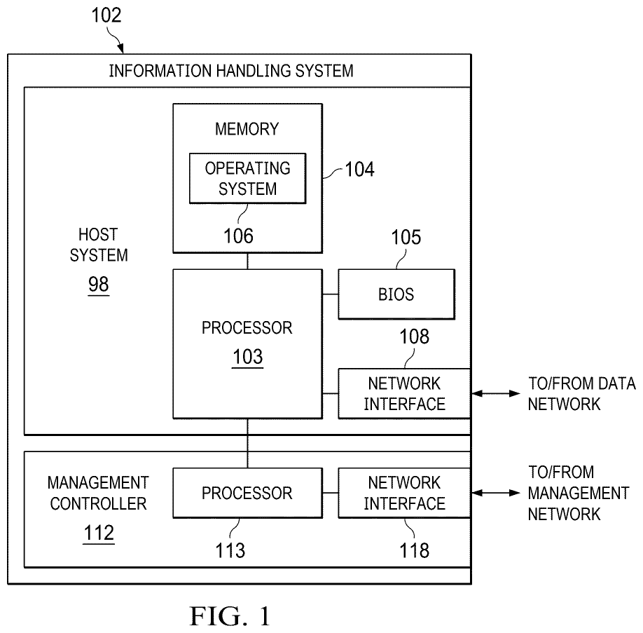

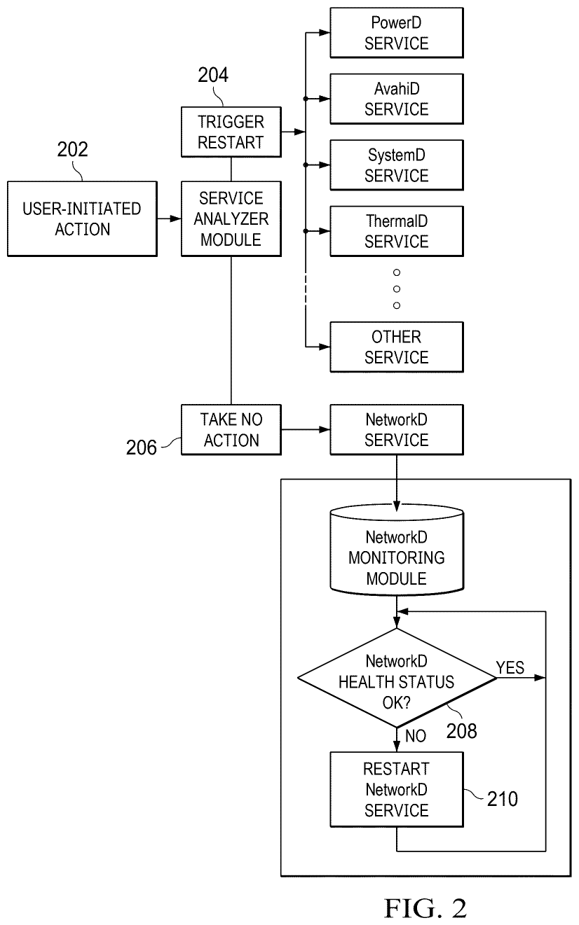

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades. ” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, a BMC such as management controller 112 may need to remain reachable via the management network to allow an administrator out-of-band management access to information handling system 102. This out-of-band access may be interrupted by certain operations that can cause the entire BMC to reboot, or that can cause certain important services executing on the BMC (e.g., AvahiD, NetworkD, PowerD, ThermalD, SystemD, etc.) to be restarted. For example, operations such as a BMC reboot, a BMC firmware update, a BMC failover condition, or a BMC configuration reset operation may cause such interruptions.

Out of all of the services mentioned above, NetworkD may be considered the most critical, because as long as it is running, an administrator may perform out-of-band management to address any other operational problems. But if NetworkD itself is not running, then the administrator may be unable to address that problem because no connection is available. NetworkD is a specific example of the general concept of a network service, which is a service that enables remote connectivity to an information handling system.

Embodiments of this disclosure prevent connectivity interruptions by protecting the network daemon NetworkD. This may be accomplished via two separate techniques. These techniques may be used separately or in conjunction with one another, in various embodiments.

In the first technique, a service analyzer module (SAM) may be used to monitor any sensitive operations being performed and intercept calls that would cause a daemon to restart. Such calls may be allowed for all services except NetworkD, but if an operation attempts to shut down or restart NetworkD, that operation may be prevented (e.g., by replacing it with a no-op).

In the second technique, a NetworkD monitoring module (NMM) may be used as a “watchdog” to monitor the NetworkD service. This module may take action if anything happens to cause the NetworkD service to crash, shut down, or otherwise become inoperable. The NMM may periodically (e.g., every two minutes) poll the status of NetworkD. If NetworkD is not operating correctly, the NMM may cause it to start or restart as appropriate.

FIG. 2 provides an example method illustrating this arrangement.

At step 202, a user-initiated action occurs. This action may include any of various sensitive actions such as a BMC reboot operation, a BMC firmware update operation, a BMC configuration reset operation, a BMC failover operation, etc. Under ordinary circumstances, any of these operations might cause one or more services executing on the BMC to restart.

When one of these sensitive operations is triggered by the user (or for some other reason), the corresponding job may be initiated by a task execution service. The SAM may be notified by the task execution service about the action. The SAM may then initiate appropriate actions based on the respective daemons that are running.

For example, the SAM may proceed with initiating the requested restart action at step 204 for any of the following daemons if they are to be restarted by the sensitive operation: PowerD, AvahiD, SystemD, ThermalD, etc. Upon receiving the restart signal from the SAM, these services will restart, interrupting their corresponding features. (For example, the PowerD service is associated with PSU and power features, which will not be available until the PowerD service restarts comes up to healthy state.)

However, for the NetworkD service, the SAM may instead initiate the “no action” trigger at step 206. Thus NetworkD will not take any action, and so the features associated with NetworkD will not be interrupted. In particular, the BMC's management IP address will continue to be remotely accessible, and the system will remain available for out-of-band management.

In some situations that call for restarting NetworkD, such a restart is not actually necessary for the overall operation to succeed, and the SAM may operate as described above. For example, if a user requests a BMC reboot, it is often sufficient to restart all of the services except NetworkD. However, in some situations it may actually be necessary for NetworkD to be restarted. In those situations, an administrator may override the operation of the SAM and manually cause NetworkD to restart.

Meanwhile, the NMM may periodically poll the NetworkD service at step 208 to ensure that it is running, responding to queries, and generally operating correctly. If so, the NMM may loop back to step 208 (e.g., with a two minute delay).

If NetworkD is not operating correctly, then at step 210, the NMM may cause it to restart.

One of ordinary skill in the art with the benefit of this disclosure will understand that the preferred initialization point for the method depicted in FIG. 2 and the order of the steps comprising that method may depend on the implementation chosen. In these and other embodiments, the method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S. C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]”construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a memory; and
a network interface;
wherein the information handling system is configured to:
receive an instruction to carry out an operation, wherein the operation includes shutting down at least one software service;
determine whether the at least one software service includes a network service configured to allow remote access to the information handling system via the network interface; and
in response to a determination that the at least one software service does include the network service, prevent the network service from shutting down.

2. The information handling system of claim 1, wherein the network interface is coupled to an out-of-band management network.

3. The information handling system of claim 1, wherein the information handling system is a baseboard management controller (BMC).

4. The information handling system of claim 1, wherein the network service is a network daemon.

5. The information handling system of claim 1, further configured to execute a network monitor, wherein the network monitor is configured to:
periodically check the health status of the network service; and
in response to a determination that the network service is not operational, cause the network service to restart.

6. The information handling system of claim 1, further configured to accept a user command to not prevent the network service from shutting down.

7. A method comprising:
an information handling system receiving an instruction to carry out an operation, wherein the operation includes shutting down at least one software service;
the information handling system determining whether the at least one software service includes a network service configured to allow remote access to the information handling system via a network interface of the information handling system; and
in response to a determination that the at least one software service does include the network service, the information handling system preventing the network service from shutting down.

8. The method of claim 7, wherein the network interface is coupled to an out-of-band management network.

9. The method of claim 7, wherein the information handling system is a baseboard management controller (BMC).

10. The method of claim 7, wherein the network service is a network daemon.

11. The method of claim 7, further comprising executing a network monitor, wherein the network monitor is configured to:
periodically check the health status of the network service; and
in response to a determination that the network service is not operational, cause the network service to restart.

12. The method of claim 7, wherein the information handling system is further configured to accept a user command to not prevent the network service from shutting down.

13. An article of manufacture comprising a non-transitory, computer-readable medium having computer-executable instructions thereon that are executable by an information handling system for:
receiving an instruction to carry out an operation, wherein the operation includes shutting down at least one software service;
determining whether the at least one software service includes a network service configured to allow remote access to the information handling system via a network interface of the information handling system; and
in response to a determination that the at least one software service does include the network service, preventing the network service from shutting down.

14. The article of manufacture of claim 13, wherein the network interface is coupled to an out-of-band management network.

15. The article of manufacture of claim 13, wherein the information handling system is a baseboard management controller (BMC).

16. The article of manufacture of claim 13, wherein the network service is a network daemon.

17. The article of manufacture of claim 13, wherein the instructions are further executable for executing a network monitor, wherein the network monitor is configured to:
periodically check the health status of the network service; and
in response to a determination that the network service is not operational, cause the network service to restart.

18. The article of manufacture of claim 13, wherein the instructions are further executable for accepting a user command to not prevent the network service from shutting down.
